(19) United States
(12) Patent Application Publication
(10) Pub. No.: US 2006/0093810 A1
(43) Pub. Date: May 4, 2006

(54) Laminated product and method for its preparation

(76) Inventors: Gary Blake, Essex (GB); Stephen Ashton, Norfolk (GB)

Correspondence Address: WOLF GREENFIELD & SACKS, PC;FEDERAL RESERVE PLAZA, 600 ATLANTIC AVENUE, BOSTON, MA, 02210-2206, US

(21) Appl. No.: 10/516,063

(22) PCT Filed: May 29, 2003
(86) PCT No.: PCT/GB03/02330

§ 371 Date: Dec. 7, 2005

(30) Foreign Application Priority Data
May 29, 2002 (EP) 02253764.1
Jul. 24, 2002 (US) 60/398048

(51) Int. Cl. B32B 27/40; B32B 27/36; B32B 27/32; B29C 71/04

(52) U.S. Cl. 428/343; 428/345; 428/423.1; 428/480; 428/523; 428/447; 427/532

(57) ABSTRACT

A laminated film (10) for application to a substrate (30) comprises at least a base layer (12), formed from an organic polymer, and an adhesive layer (16). Gamma or electron beam irradiation is applied at least to the base layer (12) to modify the polymer structure thereof, thereby strengthening the laminated film (10) and the substrate (30) to which it is applied. Glass substrates to which the laminated product is applied demonstrate improved fragment retention in the event of an impact.

### FIELD OF THE INVENTION

This invention relates to an improved laminated product, particularly such a product in the form of a film. It also relates to a process for manufacturing such a product and a substrate, especially a glass substrate, equipped with it.

### DESCRIPTION OF THE PRIOR ART

It has been known since the 1940s that the adhesion of material, such as tape, to windows can reduce the amount of glass flying from windows in the event of an explosion.

In particular, it has been known since the late 1960s to equip windows with adhesive laminated material (commonly known as window film). Adhering a window film to a glass window aids the retention of glass fragments and inhibits spalling flying from the window in the event of an impact such as an explosion, bomb blast, hand-held or thrown missile, or an accidental impact such as a person colliding with the window.

The laminated film typically comprises:

(a) one or more base layers, usually comprising an organic polymer (which may be, for example, a polyester such as polyethylene terephthalate (PET), a polyalkene such as polyethylene or polypropylene, or a substituted polyalkene such as polyvinyl chloride, polyvinyl acetate, but is preferably PET), the thickness of which may vary;

(b) one or more adhesive layers, which may also be of various thicknesses and the function of which is to adhere the base layer(s) to the substrate; and

(c) a protective layer, the function of which is to protect the adhesive layer before application of the laminated film to the substrate (examples of which include release liners and detackifiers); the protective layer is removed when the laminated film is applied to the substrate.

The laminated film may optionally include other layers such as:

(d) a scratch resistant coating layer (examples of which include those disclosed in GB-A-2199285 and U.S. Pat. No. 4,557,980);

(e) one or more optical film layers, the function of which is to affect the optical transmission or reflection of the film by absorption or reflection of radiation of certain wavelengths, examples of which include metal layers (non-limiting examples of the metal include aluminium, copper, silver, gold, titanium and palladium), grey filters and ultraviolet absorption layers; the optical film layer(s) may form part of one or more of the base and/or adhesive layers (for example, in the window film available from CP Films Inc. of Martinsville, Va., USA, a UV absorption layer is incorporated into the base layer).

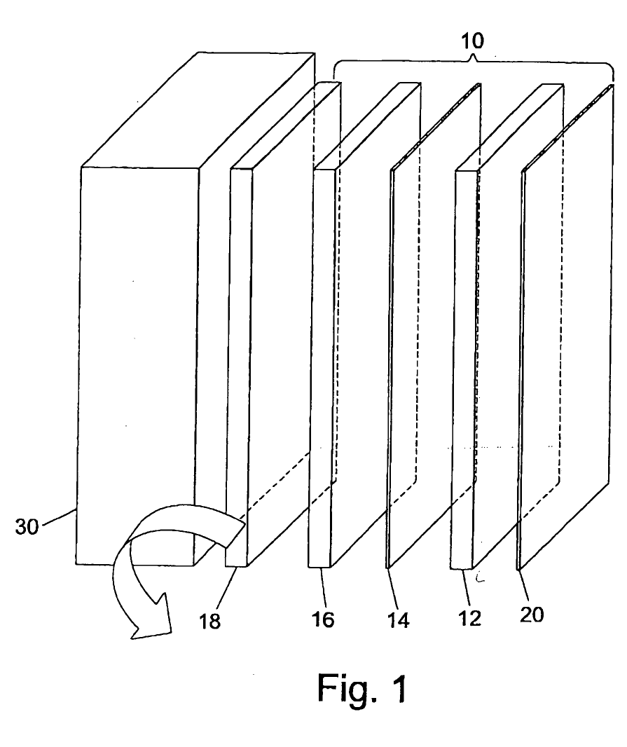

One example of a window film known in the art is illustrated in FIG. 1. The film 10 comprises a base layer 12 of PET provided on one face with a laminated adhesive layer 14 (the function of which is to bond multiple layers of PET film together) and a pressure sensitive mounting adhesive layer 16 (the function of which is to laminate the film to glass substrate 30). The pressure sensitive mounting adhesive layer incorporates an ultraviolet absorber. The adhesive layer is protected with a disposable release liner 18. On the other face of the base layer 12 is provided a scratch resistant coating 20. Such a window film is available from CP Films Inc. of Martinsville, Va.

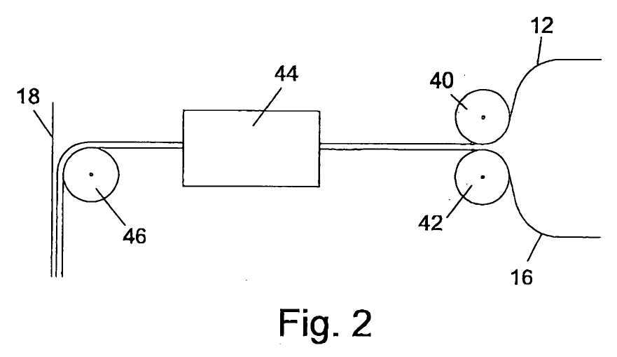

Window film may be made by the process illustrated schematically in FIG. 2. Sheets of the base layer 12 (which is generally surface coated by means of a process such as Graver coating or Croner discharge, to enable adhesion of the adhesive layer thereto) which may be coated on one side with a scratch resistant coating, and adhesive layer 16 (the adhesive layer being dissolved in a solvent, the nature of which is not especially critical provided it is capable of at least partially dissolving the adhesive layer) are brought together by reels 40, 42. The base and adhesive layers then pass through a solvent extractor 44 in order to remove excess solvent. The protective layer 18 is then applied to the dried base and adhesive layers by means of a pinch roller 46.

Such a process is generally suitable for the manufacture of thin single ply films up to around 200 μm. Thicker films (around 250-350 μm) may typically be built up by a number of different thicknesses of base layer being laminated together by means of a laminating adhesive to reach the required thickness. For example, solar films, generally comprise a metal layer sandwiched between two base layers; the principal function of such films is to wholly or partially absorb or reflect solar energy. Solar film may be laminated to a base layer of 100 μm thickness by means of a laminating adhesive, the resulting film being generally known in the art as security/solar control film.

Metal layers may be incorporated into the laminated film by sputter coating or vacuum coating the base layer prior to application of the adhesive layer. Vapour coating is particularly suitable for application of an aluminium layer and sputter coating for other metal layer such as copper, silver, gold, titanium and palladium. These techniques are well known to the skilled person and are not the subject of this invention.

The window film may be applied to a substrate, especially a glass substrate, according to the following procedure. Initially, the substrate may be cleaned and any markings removed therefrom. The protective layer is then removed in order to expose the adhesive layer. The film is then applied to the substrate so that the adhesive layer adheres thereto, before pressure is applied to the opposite side of the base layer in order to secure adhesion and remove air bubbles. A liquid, preferably water (which may have a surfactant dissolved therein), may be applied to the adhesive layer, typically by spraying, prior to its application to the substrate. This enables air bubbles to be expelled more easily.

Since the introduction of window film, a problem that has always been encountered is the quality of adhesion between the base layer and the glass substrate, as the physical performance characteristics of the organic base layer and the silica-based glass substrates are very different.

One particular problem encountered in the field of glazing, particularly with the use of toughened glass, is that of nickel sulphide (NiS) inclusion, also known as “glass cancer”. This problem, widely recognised since the early 1960s, can cause glass, especially toughened or tempered glass, to shatter spontaneously. To date, no satisfactory solution to this problem has been proposed. It is therefore desirable to ensure that the public is properly protected from glass fragments flying from a panel which has failed due to NiS inclusion.

It is generally known in the art that increasing the thickness of the base layer and/or the adhesive layer stiffens the layers and reinforces the substrate against an impact. However, increasing the thickness of the base layer also increases the cost and makes adhesion of the film to a substrate more difficult. Furthermore, organic polymers such as polyester film are based on crude oil, which is a finite resource. Therefore, for both environmental and cost reasons, it is desirable to keep the base layer as thin as possible, thereby using as little raw material as possible while maintaining the integrity of the substrate against an explosion. A thinner base layer also enables the end user to apply the laminated film to a substrate more easily and more quickly.

The application of electromagnetic radiation to polymers is known in the art. For example, the use of irradiation and electron beams is a well proven and tested process in, for example, the sterilisation of medical equipment. Sterilisation by radiation is achieved by two similar but distinct technologies, namely gamma irradiation and electron beam irradiation. Gamma irradiation involves exposure of products to gamma rays generated by a radioactive source, such as cobalt-60, in a specially designed irradiation cell. This high energy radiation is powerful enough to destroy biological systems but is not sufficiently energetic to interact with nuclei and induce radioactivity in the materials.

Without wishing to be bound by theory, it is believed that, as rays penetrate the product, photons of incident gamma radiation gradually give up their energy to electrons within the polymer. This will result in a shower of energetic electrons within the polymer, which may be either free or remain bound. The ejected electrons may recombine to generate super excited molecules which can then undergo cleavage to form active free radicals. Alternatively the parent cation may undergo spontaneous decomposition or ion-molecule reactions, with the ejected electrons becoming stabilised by interactions with polar groups, or as a solvated species or ion radical. This scattering of electrons and generation of excited free radicals and molecules is known as the Compton Effect. Whether and which of these mechanisms takes place will depend on the constituents and the configuration of the targeted molecules.

Electron beam irradiation involves the exposure of product to a high energy (typically 5-10 MeV) beam of accelerated electrons. These electrons will penetrate the product polymer and, by direct interaction with electrons within the polymer, will generate a similar electron shower and similar reactions to those described above for gamma irradiation. Consequently, similar free radicals and activated species will be formed and similar reactions will occur.

Irradiation has also been applied to polymers in the field of safety glazing. For example, U.S. Pat. No. 5,190,825 discloses the production of an adhesive material usable as an intermediate layer in the manufacture of laminated glass. The adhesive layer comprises an organic polymer resin (typically polyurethane, polyvinyl chloride or polyvinyl butyrate) which has unsaturated monomers, such as acrylic monomers, radiochemically grafted to at least one surface thereof. The grafting is carried out using electron beam such that a radiation dosage of around 1 kilogray (kGy) (one gray is equivalent to the absorption of one joule of energy by one kilogram of material) is applied to the adhesive layer. The adhesive layer is used to bind together two layers of polymethyl methacrylate (PMMA) in order to form a laminated glass product.

Another example of such a process is disclosed in U.S. Pat. No. 4,511,627, which discloses a “sandwich” glass having two glass plates adhered together by an intermediate adhesive layer. The adhesive layer typically comprises ethylene-vinyl acetate copolymer, which is photochemically cross-linked by ultravioletvisible radiation.

However, in the event of an impact, the laminated glass products described in both of the above US patents frequently undergo rear face spalling (glass shrapnel from the rear layers, ie those remote from to the impact, piercing the film). Because of this, such laminated glass products do not consistently provide adequate protection from impact.

JP-A60/013,824 discloses a process for adhering two or more panes of laminated glass together, whereby an adhesive polyurethane resin is contacted with a reactive compound having both an unsaturated group and a carboxylic acid group. The resin may be exposed to irradiation, such as ultraviolet radiation or electron beams, in order to cross-link the reactive functional groups.

JP-A-61/044741 discloses a process whereby an ethylene-vinyl acetate copolymer is blended with a peroxide. The adhesive resin is then placed between two plates to give a laminated product. The resin is irradiated with ultraviolet light to cross-link the product

U.S. Pat. No. 5,804,025 discloses the application to a PET substrate of electromagnetic radiation in the radiofrequency region of the electromagnetic spectrum. The radiation applied is of sufficient intensity and duration to melt the substrate and thereby finds application in welding PET articles together. However, the document does not disclose the use of higher-frequency radiation or electron beams, nor that irradiation of PET might improve adhesion between this polymer and an adhesive layer and/or to a glass substrate.

EP-A-522251 discloses a partially crystalline polyester film prepared by radiation cross-linking of partially crystalline,”substantially linear polyesters solid at room temperature. The polyesters have a glass transition temperature of less than −20° C., a heat of fusion of greater than 20 J/g, preferably greater than 40 J/g, and a molecular mass of 1000 to 10 000. Between 50% and 90% of free hydroxy groups on the polymers described in this document are acrylated or methacrylated. The partially crystalline film may be cross linked with irradiation with an electron beam or ultra violet light. The polymer is stated to be useful for preparing adhesive films and other self-adhesive articles.

However, several problems are associated with the use of chemically modified, and particularly acrylater or methacrylated, polyesters:
It is necessary to use a chemical reagent to introduce the acrylate or methacrylate groups into the polymer—this inevitably results in the resultant polymer containing impurities.
It is necessary to carry out the reaction in the presence of a solvent, usually an organic solvent, in order to allow the reagent molecules to penetrate film structure. The use of solvents increases the cost of the film, and the detrimental effect on the environment of organic solvents is well known.
Acrylates and methacrylates are well known in the art to be harmful to the users and to the environment, and are suspected carcinogens.
A chemically modified base film cannot bond to an adhesive layer by cross-linking and/or cross-scission.

For these reasons, the chemically modified polymer disclosed in EP-A-522251 is wholly unsuitable for use as window film.

WO 01/02508 discloses a pressure-sensitive adhesive sheet comprising a base layer formed from a fluorine-containing polymer, an adhesive layer, and optionally, one or more intermediate layers. Irradiation of the sheet with an electron beam causes the base layer to bond to the adhesive and/or the intermediate layer. However, the document does not disclose that the sheet may be formed from non-fluorinated polymers, nor that the irradiation may be carried out using gamma rays.

GB 815823 discloses a pressure-sensitive adhesive tape comprising a polyethylene base layer and a pressure sensitive adhesive, wherein the base layer is irradiated with high energy electrons. The dosage of irradiation varies between 2×10⁸ and 15×10⁶ roentgens. However, the document does not disclose adhesive tapes formed from a PET base layer, nor that the base layer may be modified by gamma radiation.

DE-A-19757426 discloses an adhesive tape comprising a pressure-sensitive layer and an elastomeric backing layer (which may be formed from natural rubber, or a mixture of natural rubber and styrene-butadiene rubber). The backing layer contains-a cross-linker which, when irradiated with electrons, cross links the framework of the backing layer and/or the cross-linker. The tape may be irradiated with an electron beam. The adhesive layer may also be cross linked, either separately or in combination with the base layer and any intermediate layers. However, the document does not disclose an adhesive tape comprising a polyester base layer, nor that the base layer may be irradiated with gamma rays.

GB-A-2331269 discloses a window film comprising a polypropylene layer having a metallised layer on one side and a light transmissive adhesive on the other side. The document does not mention that the film may be irradiated.

U.S. Pat. No. 5,987,949 discloses an adhesive tape comprising a foam backing coated with a self-adhesive composition. The adhesive layer can be cross-linked chemically (for example, by UV radiation, gamma radiation or irradiation with rapid electrons). However, the document does not mention that the backing layer may be irradiated.

It is therefore an objective of the present invention to provide a laminated product for application to a substrate, in particular a glass substrate, capable of strengthening the substrate against and, in the case of glass substrates, ensuring improved fragment retention in the event of an impact (in particular, an explosion) or a spontaneous failure such as those caused by NiS inclusion.

### SUMMARY OF INVENTION

There is therefore provided according to a first aspect of the present invention a laminated product for application to a substrate, the product comprising:

(a) a base layer comprising a chemically unmodified organic polymer selected from phenolic resins, polyurethanes, polypropylene and polyesters; and

(b) an adhesive layer,

wherein at least the base layer is modified by irradiation.

There is also provided according to a second aspect of the present invention a process for producing a laminated product comprising, in any order, steps (a) and (b):

(a) applying an adhesive layer to a base layer comprising a chemically unmodified organic polymer selected from phenolic resins, polyurethanes, polypropylene and polyesters, and

(b) irradiating and thereby modifying at least the base layer.

There is also provided according to a third aspect of the present invention a substrate, in particular a glass substrate such as a window or door panel, provided with a laminated product (in particular, in the form of a film) according to the invention.

### DETAILED DESCRIPTION OF PREFERRED EMBODIMENTS

In the laminated product according to the present invention, the base layer is formed from an organic polymer, the nature of which is not especially critical. Non-limiting examples of suitable polymers include polyesters such as polyethylene terephthalate (PET) and polybutylene terephthalate (PBT), polypropylene, phenolic resins; polyurethanes; copolymers of any of the above, and blends of any of the above polymers and/or copolymers thereof. We prefer that the base layer is formed from a polyester such as PET or PBT, and PET is most preferred.

The laminated product may include a single base layer or a plurality of base layers. When the laminated product includes a plurality of base layers, the base layers may be adhered together by a laminating adhesive (which is generally formed from a polymer and/or acrylic based products).

The base layer may contain additives, the nature and type of which are well known to those skilled in the art and are not critical to the present invention. Examples of possible additives include those described above, as well as dyes, metal layers, sputter coatings, reflective coatings and anti bacterial agents. For example, a metal layer may be sandwiched between two PET base layers to produce a base layer for a solar film-The base layer is chemically unmodified, in that no chemical agents are used to modify the base layer prior to irradiation and bonding to the adhesive layer, so that no further groups (other than those present in the monomers and those present as a result of cross-linking and/or chain scission) are present in the polymer. This confers a number of advantages over the prior art, as follows.
As no chemical reagents are used, the resultant polymer contains fewer impurities and is therefore stronger and contains fewer defects.
The process can be carried out in the absence of a solvent, thereby avoiding the additional cost and environmental impact of solvents.
The detrimental impact to human health and the environment of acrylates and mnethacrylates can be avoided.

It is believed that irradiation of a chemically unmodified base layer allows the polymer chains of the base layer to crosslink not only to one another (film-film cross-linking) but also to the adhesive layer (film-adhesive cross-linking); as outlined above, this is not possible for chemically modified base layers.

The composition of the adhesive layer is not particularly critical, provided that it can provide some degree of adhesion between the base layer and the substrate to which the laminated product is applied, in particular to a glass substrate. Unless specified otherwise, in this specification the term “adhesive layer” refers to the mounting adhesive used to adhere the base layer to the substrate, as opposed to a laminating adhesive used to adhere multiple base layers together. For example, the adhesive layer may be a vinyl-type adhesive, for example polyvinyl acetate; a polyester resin; an epoxy-based adhesive such as Araldite®; ethylene-vinyl acetate copolymer; a pressure sensitive adhesive (which are typically based on acrylic monomers) or a clear, distortion-free adhesive (which is generally formed from acrylic monomers, and may optionally be cross-linked and/or UV-cured) or a water activated adhesive (an example of which is the water-activated adhesive present in the shatter-resistant film available from 3M of St. Paul, Minn., USA under product codes P18 and P19). Particularly preferred examples of materials used for the adhesive layer include the pressure sensitive acrylic adhesive and/or the clear, distortion-free adhesive and/or the water activated adhesive used in the film available from CP Films Inc. of Martinsville, Va., USA.

The laminated product may include a single adhesive layer or a plurality of adhesive layers.

The adhesive may also contain additives, the nature and type of which are well known to those skilled in the polymer arts. Examples of possible additives include those listed above in relation to the base layer. In particular, the additives may be formulated so as to improve adhesion of the laminated product to the substrate.

The adhesive layer may be applied to base layer by any method known in the art of coating techniques. For example, the adhesive layer may be applied to the base layer according to the method described above with reference to FIG. 2. Alternatively, the adhesive layer may be dissolved in a solvent (the nature of which is not especially critical provided it is capable of at least partially dissolving the adhesive layer), into which the base layer is dipped; the solvent is then allowed to evaporate to leave the base layer coated with the adhesive layer. The adhesive layer may also be applied to the base layer by spraying.

The laminated product also typically includes a protective layer. The nature of the protective layer is not critical to the present invention, provided that it is suitable for covering the adhesive layer before application of the laminated product to the substrate Examples of suitable protective layers include a release liner (typically made from polypropylene) which may optionally be coated with silicone, and/or a detackifier. One example of a release liner is that available from HP Smith of Texas, USA.

The laminated product may preferably include a scratch resistant protective layer, the nature of which is not critical provided it is scratch resistant, in other words it protects the surface of the laminated product from being roughened. Scratch resistant layers are well known in the art and not the subject of this invention. For examples, the scratch resistant coating may be formed by radiation-polymerising a mixture of radiation-polymerisable monomers comprising a triacrylate or tetraacrylate monomer and acrylic acid. Such a scratch resistant coating is disclosed in GB-A-2199285 and U.S. Pat. No. 4,557,980. Scratch resistance may be measured by the method disclosed in U.S. Pat. No. 4,557,890. The haze value of the surface of a sample of the product is measured using a conventional Hunter haze measurement device. The sample is then abraded on a Tabor abrader as described in ASTM D 1004-56 (CS10 wheels, 1 kg load per wheel and 100 cycles), and the haze is again measured. The change in haze (delta haze) is a measure of scratch resistance. Examples of scratch resistant coatings are those available on the window films available from CP Films Inc. of Martinsville, Va., USA, and 3M of St. Paul, Minn., USA.

At least the base layer of the laminated product is irradiated. The term ‘irradiation’ as used in this specification means exposure of the laminated product (or part thereof) to radiation capable of modifying the polymer structure so as to strengthen the laminated product including the polymer and the substrate to which it is applied (in particular, to provide improved fragment retention on a glass substrate to which the laminated product is applied in the event of an impact or a spontaneous failure).

The irradiation of the base layer modifies the structure of the polymer. Without wishing to be bound by theory, it is believed that the ultimate result of the radiation is a change in polymer molecular weight, either a decrease by chain scission or an increase by cross-linking. Both these mechanisms will take place in polymers, but one will usually predominate. Polymers with largely unsubstituted carbon to carbon aliphatic backbones (such as polyethylene) exhibit predominately cross-linking whilst chain scission will prevail in polymers possessing a quaternary substituted carbon atom (such as polyisobutylene). Preferably, the irradiation is capable of achieving cross-linking and/or cross-scission of the polymer structure.

The base layer may be irradiated either prior to application of the adhesive layer, or after application of the adhesive layer. However, it is preferred that both the base layer and the adhesive layer are irradiated, ie the base layer is irradiated after application of the adhesive layer. Without wishing to be bound by theory, it is believed that irradiation of the base layer after application of the adhesive layer causes the polymer chains of the base layer to cross-link not only to one another (film-film cross-linking) but also to the adhesive layer (film-adhesive cross-linking). This greatly increases the strength of a substrate equipped with the laminated product, particularly against impact or spontaneous failure.

The irradiation may, for example, be electromagnetic radiation, in particular, high-frequency electromagnetic radiation such as gamma radiation. Gamma radiation from a cobalt-60 source is preferred.

Alternatively, the irradiation may comprise an electron beam (ie a stream of electrons accelerated by an electrical field). Without wishing to be bound by theory, it is believed that the high-energy electrons cause ionisation in the irradiated base layer (and, optionally, the adhesive layer), causing reactions such as cross-linking and cross-scission.

The time required to achieve a given absorbed dose is much shorter with electron beam radiation than with gamma radiation. As a result of these two characteristics, the temperature rise associated with electron beam irradiation tends to be much greater than for gamma radiation (3-4° C. per 10 kGy for electron beam radiation) and the degree of oxidation reactions taking place is generally reduced if electron beam irradiation is used. Furthermore, electron beam irradiation may be incorporated more easily into the manufacturing process of the laminated product.

The dosage of irradiation used will vary depending on the nature and thickness of the base layer, the adhesive layer, and the substrate to which the laminated product is intended to be applied. However, we prefer that the dosage of irradiation used is from 0.001 kGy to 10⁵ kGy, more preferably 0.01 kGy to 1000 kGy, still more preferably 0.1 ky to 500 kGy, even more preferably 1 kGy to 200 kGy, and most preferably 75 kGy to 126 kGy. In one particular example, the dosage of irradiation applied to the base layer is about 100 kGy. In another embodiments the dosage of irradiation used is from 25 kGy to 85 kGy, more preferably 35 kGy to 75 kGy, and most preferably 55 kGy. It should be noted that, due to the nature of radioactivity in general and of the irradiating processes used, this dosage is not an exact quantity but varies within a tolerance range. A dose-meter (for example, that available from Harwell Dosimeters, UK) may be applied to the inside, outside or both of the product in order to ensure that the irradiation is constant throughout the product and controllable from a technical point of view.

The duration of irradiation used will vary depending on factors such as the nature and thickness of the base layer, the adhesive layer, the substrate to which the laminated product is intended to be applied, and the means of irradiation used. However, we prefer that the duration of irradiation is from 1 minute to 100 days, more preferably 10 minutes to 10 days, still more preferably 1 hour to 20 days, even more preferably 10 hours to 40 hours, and most preferably 15 hours to 25 hours.

The laminated product of the present invention, especially when in the form of a film, may be applied to any substrate for which strengthening against impact is desired. The laminated product is, of course, particularly suitable for use with glass substrates such as windows, door panels and the like. Any glass known in the art may be fitted with the laminated product of the present invention and thereby become strengthened against an impact. In the event of such an impact, the glass substrate equipped with the laminated product of the present invention does not delaminate or tear, and glass shrapnel does not penetrate through the film, thereby reducing the risk of injury to bystanders. Non-limiting examples of glass substrates which may be equipped with the laminated product of the present invention include float glass, tempered glass, toughened glass, annealed glass, laminated glass (for example, some of the laminated glasses disclosed in the prior art US patents described above) and wired glass. The laminated product of the present invention may be fitted to a glass substrate by any suitable means known in the art, including that described above.

After application, the substrate having the laminated product is cured. The time and temperature of the curing process varies depending on factors such as the nature and thickness of the laminated product and the substrate to which it is applied. However, we prefer that the curing is carried out at a temperature ranging from 0° C. to 200° C., more preferably from 10° C. to 50° C. The duration of the curing process is preferably from 1 to 200 days, more preferably from 20 to 150 days. The curing process may be accelerated by the application of heat, such as from an industrial hairdryer.

The invention will now be described in more detail by means of the following Examples and Test Examples. However, it should be understood that the scope of the invention is not limited to or by these Examples.

### EXAMPLES

Four samples of polyethylene terephthalate window film of dimensions 61 cm×61 cm×100 μm (thickness), described hereinbelow as Examples A to D, were cut from a roll (the roll including a scratch resistant coating, available from CP Films Inc., of Martinsville. Va., USA, under product code SCL SRPS4).

The samples were irradiated by gamma radiation from a cobalt-60 source at the Isotron Gamma Processing Plant, Swindon, UK. The dosage of radiation received by each sample is given in Table 1.

TABLE 1

| Example | Radiation dosage (kGy) |
|---|---|
| A | 60 |
| B | 100 |
| C | 140 |
| D | 180 |

The following 100 μm films, listed in Table 2, were used as Control Examples.

TABLE 2

| Control | |
|---|---|
| Example | Source |
| A | CP Films Inc., Martinsville, Virginia, USA (product code |
| | SCL SRPS4) |
| B | CP Films Inc., Martinsville, Virginia, USA (product code |
| | SCL SRPS4) |
| C | Hannita Kibbutz, Israel (product code SACPS 4mil Clear) |
| D | 3M, St. Paul, Minnesota, USA (product code SH4CLARL) |
| E | MADICO, USA (product code CL400 XSR) |
| F | Johnsons Window Film, California, USA (product code |
| | SEC04/4mil Clear) |
| G | Film Technology Inc. (formerly Sunguard), Florida, USA |
| | (product code GG400/NRW-400 C90) |
| H | DTI, California, USA (product code 4mil Clear) |
| I | Garware Films, India (product code 100 Micron Clear) |

The films used in Control Examples A and B were identical in all respects with those of Examples A to D, except that they were not irradiated.

The Example and Control Example films were each applied to one side of identical panes of 61 cm×61 cm×6 mm float glass (available from Pilkington Glass Co. Ltd. England). The panes with the applied film were then left to cure naturally for a minimum of 30 days at an average temperature of 15-18° C.

### Test Examples 1 and 2

### Impact Test

An impact test was used to compare the relative strength of the above samples of window film. The cured glass panes were inserted into a rough wooden frame which has a 10 mm rebate routed out, enabling the glass to be fitted to a depth all round of 6 mm. The 4 mm excess width is designed to replicate the weakest form of glazing used in situ, as the majority of window film is retrofitted (ie fitted to windows already installed in existing buildings).

### Test Example 1

An impacter weighing 2 kg and having a diameter of 76 mm was dropped from 3 metres and allowed to free fall so that it impacted on the centre of the pane. This imparted a kinetic energy of 58.92 J on impact.

The performance of the window film was assessed on the following criteria:

Delamination—The film applied to the rear face of the pane must not delaminate on impact.

Tearing/splitting—The film applied to the rear face of the pane must not split or tear on impact.

Rear face scalling—The film must not allow any glass fragments to pass through to the side of the glass remote from the impact.

Provided all the above criteria are met, the window film is considered to have passed the test.

The panes fitted with the window film according to the Examples and Control Examples was tested according to the above protocol. The results are shown in Table 3, in which the following abbreviations are used:

TABLE 3

| | | | | Pass/ |
|---|---|---|---|---|
| Ex/Control Ex | T | D | RS | Fail |
| Control Ex A | Considerable | Considerable | Considerable | Fail |
| Control Ex B | Considerable | Considerable | Considerable | Fail |
| Control Ex C | Considerable | Considerable | Considerable | Fail |
| Control Ex D | Considerable | Considerable | Considerable | Fail |
| Control Ex E | Considerable | Considerable | Considerable | Fail |
| Control Ex F | Considerable | Considerable | Considerable | Fail |
| Control Ex G | Considerable | Considerable | Considerable | Fail |
| Control Ex H | Considerable | Considerable | Considerable | Fail |
| Control Ex I | Considerable | Considerable | Considerable | Fail |
| Example A | None | Minimal, at edges | None | Pass |
| Example B | None | None | None | Pass |
| Example C | None | None | None | Pass |
| Example D | None | None | None | Pass |

D = Delamination
T = Tearing
RS = Rear spalling

Analysis of the break pattern of the glass indicated that the film of Example B possessed optimum impact strength.

### Test Example 2

Test Example 1 was repeated, except that an impacter weighing 2.5 kg was used. This imparted a kinetic energy of 73-65 J on impact.

The impacter was allowed to free fall so that it impacted on the centre of a pane of glass equipped with the window film identical to that of Example B. The impacter was then allowed to free fall from the same height on the same glass pane.

The results are shown in Table 4.

TABLE 4

| Example | T | D | RS | Pass/Fail |
|---|---|---|---|---|
| Example B | None | None | None | Pass |
| (1st impact) | | | | |
| Example B | None | None | None | Pass |
| (2nd impact) | | | | |

The above shows that the window film of Example B exhibits sufficient strength such that it does not delaminate, split or tear, nor allow any glass fragments to pass through to the other side even when a glass pane fitted with it is subjected twice to the increased impact energy used in this Test Example. The window film of Example B therefore represents a preferred embodiment of the invention.

### Test Example 3

### Physical Attack Test

In order to demonstrate the resistance to physical attack of a substrate equipped with the window film of the present invention, two double glazed units of dimensions 1.50 m×1.82 m consisting of a 7.5 mm 3 ply laminated glass (having two glass layers with a polyvinyl butyral layer between the layers) equipped on the outside with film of 175 μM thickness, a 12 mm ambient air space and then a 6 mm toughened glass pane equipped with film of 100 μm thickness on the inside were struck with various implements. The aim of the attack was to form a hole in the glass and film of sufficient size to enable an adult human to pass through.

The film in one of the units received 100 kGy of irradiation. The other unit was used as a control and was identical in all respects, except for the fact that the window film was not irradiated.

The results are shown in Table 5.

TABLE 5

| Implement | Result (control) | Result (invention) |
|---|---|---|
| Wooden | Glass broke in immediate area | No damage caused to glass. Bat |
| baseball bat | (approx. 10 cm radius) of impact | broke after 2nd blow |
| (approx wt | on 1st blow; no holes made in film | |
| 200 g) | after 7 blows | |
| Metal bar | Glass broke in approx. 15 cm | Glass broke evenly on 3rd blow. Bar |
| (approx wt | radius) of impact on 1st blow; no | bent after 7 blows. No rear face |
| 500 g) | holes made in film after 5 blows | spalling or holes in firm after 12 blows |
| Sledgehammer | Glass shattered; human hand- | Glass broke in immediate area |
| (approx wt | sized hole pierced in film on 1st | (approx. 10 cm radius) of impact. No |
| 6.5 kg) | blow; pane and film collapsed | holes pierced in film after 10 blows |
| | after 18 blows | |
| Pick-axe | Not required | Only finger-sized holes made in film |
| (approx wt | | after 9 blows |
| 5.5 kg) | | |

The above demonstrates that a glass substrate equipped with the window film of the present invention exhibits significantly greater resistance to physical attack when compared with a glass substrate equipped with otherwise identical window film.

### Test Example 4

### Further Impact Tests

In order to demonstrate the applicability of the present invention to a broad range of window films, further impact tests were carried out on glass panes equipped with 100 μm thick window film from a number of different manufacturers. In each case, the films were cut from a roll in the same manner, and to the same dimensions, as outlined in the Examples above.

One sample of film from each source was irradiated with 100 kGy of gamma radiation at Isotron Nederland B. V., Netherlands—the treated samples are described hereinafter as Examples J to N. An otherwise identical sample from each source was used as a control (the controls are hereinafter referred to as Control Examples J to N). The sources of each sample are listed in Table 6 below

TABLE 6

| Example/ | |
|---|---|
| Control | |
| Example | Source |
| J | Commonwealth Laminated Corporation, USA |
| K | Johnson's, USA (identical to Control Example F) |
| L | Madico, USA (identical to Control Example E) |
| M | 3M, USA (26 layers) (Ultra 400) (identical to Control |
| | Example D) |
| N | CP Films Ltd., UK (identical to Control Examples A & B) |

The above Example and Control Example films were each applied to one side of identical panes of glass and allowed to cure under the same conditions as outlined above.

Impacters of varying types and masses were dropped from 3 metres onto the centre of each pane in a similar manner to that described in Test Examples 1 and 2. In each test, the pane was held level at 90 mm from the ground. The glass has no beadings or gaskets and no other type of cushioning or holding to keep it in the frame. It is the weakest possible glass holding frame, designed to force the filmed glass to absorb all the impact energy. With the exception of Example/Control Example L, the same impacter was used on each Example as on the corresponding Control Example.

The results are shown in Table 7. The same abbreviations are used as in Tables 3 and 4 above.

TABLE 7

| Example/ | | | Result |
|---|---|---|---|
| Ctrl Example | Impacter | Result (Example) | (Control Example) |
| J | 1.5 kg ball | Pass (see below) | Fail |
| K | 1.8 kg ball | Pass | Fail (significant T, D) |
| L | 1.0 kg ball | Pass | Fail (significant D) |
| | (Ctrl Ex), | | |
| | 2.0 kg ball (Ex) | | |
| M | 2.5 kg ball | Pass (some D) | Fail (significant |
| | | | T, D, RS) |
| N | 2.0 kg bomb | Excellent pass - | Fail |
| (Test 1) | | no RS | |
| N | 2.0 kg ball | Excellent pass - | Fail (significant T) |
| (Test 2) | | no T or D | |

The film prepared according to Example N was considered an excellent pass due to the break pattern exhibited. The glass broke into small pieces in a similar manner to toughened or tempered glass, thus demonstrating that the glass equipped with the film of Example N absorbed and dissipated more of the impact energy.

In contrast, the glass panel equipped with the film of Example J, although passing the tests outlined above, broke into larger pieces on impact, thus demonstrating that a much smaller proportion of the impact energy was absorbed.

The above demonstrates that irradiation of window film according to the present invention confers a considerable improvement in impact strength compared with otherwise identical window film which has not undergone irradiation.

1. A laminated product for application to a substrate in order to strengthen said substrate against impact, the product comprising:
(a) a base layer comprising a chemically unmodified organic polymer selected from phenolic resins, polyurethanes, silicones, polypropylene and polyesters; and
(b) an adhesive layer;
wherein at least the base layer is modified by irradiation.

2. A laminated product according to claim 1, wherein the base layer is formed from a polyester.

3. A laminated product according to claim 2, wherein the base layer is formed from polyethylene terephthalate.

4. A laminated product according to claim 1, wherein the adhesive layer is a pressure sensitive adhesive.

5. A laminated product according to claim 1, wherein the adhesive layer is a clear, distortion-free adhesive.

6. A laminated product according to claim 1, wherein the adhesive layer is a water activated adhesive.

7. A laminated product according to claim 1, further comprising a protective layer.

8. A laminated product according to claim 1, further comprising a scratch resistant protective layer.

9. A laminated product according to claim 1 in the form of a film.

10. A process for producing a laminated product for application to a substrate in order to strengthen said substrate against impact comprising, in any order, steps (a) and (b):
(a) applying an adhesive layer to a base layer comprising a chemically unmodified organic polymer selected from phenolic resins, polyurethanes, silicones, polypropylene and polyesters; and
(b) irradiating and thereby modifying at least the base layer.

11. A process according to claim 10, wherein step (b) takes place after step (a), such that both the base layer and the adhesive layer are irradiated.

12. A process according to claim 10, wherein the irradiation is capable of achieving cross-linking and/or cross-scission of the structure of at least the base layer.

13. A process according to claim 10, wherein the irradiation is gamma radiation.

14. A process according to claim 10, wherein the irradiation comprises an electron beam.

15. A process according to claim 10, wherein the dosage of irradiation used is from 0.001 kGy to 10⁵ kGy.

16. A process according to claim 15, wherein the dosage of irradiation used is from 1 kGy to 200 kGy.

17. A process according to claim 16, wherein the dosage of irradiation used is from 75 kGy to 125 kGy.

18. A process according to claim 16, wherein the dosage of irradiation used is from 35 kGy to 75 kGy.

19. A substrate to which has been applied a laminated product in order to strengthen said substrate against impact, said laminated product comprising:
(a) a base layer comprising a chemically unmodified organic polymer selected from phenolic resins, polyurethanes, silicones, polypropylene and polyesters; and
(b) an adhesive layer;
wherein at least the base layer is modified by irradiation.

20. A substrate according to claim 19, wherein the base layer is formed from a polyester.

21. A substrate according to claim 20, wherein the base layer is formed from polyethylene terephthalate.

22. A substrate according to claim 19, wherein the adhesive layer is a pressure sensitive adhesive.

23. A substrate according to claim 19, wherein the adhesive layer is a clear, distortion-free adhesive.

24. A substrate according to claim 19, wherein the adhesive layer is a water activated adhesive.

25. A substrate according to claim 19, wherein the laminated product further comprises a protective layer.

26. A substrate according to claim 19, wherein the laminated product further comprises a scratch resistant protective layer.

27. A substrate according to claim 19, wherein the laminated product is in the form of a film.

28. A substrate according to claim 19, selected from a window and a door panel.

29. A substrate according to claim 19 which is made from glass.
